(19) United States
(12) Patent Application Publication
(10) Pub. No.: US 2008/0154722 A1
(43) Pub. Date: Jun. 26, 2008

(54) Methods and apparatus for implementing a promotional reward program

(76) Inventor: John Galinos, New York, NY (US)

Correspondence Address: Robert T. Maldonado;Cooper & Dunham LLP, 1185 Avenue of the Americas, New York, NY, 10036, US

(21) Appl. No.: 11/901,812

(22) Filed: Sep. 19, 2007

Related U.S. Application Data
(63) Continuation-in-part of application No. 11/643,234, filed on Dec. 20, 2006.

(51) Int. Cl. G06Q 30/00; G06F 17/40; G06F 19/00

(52) U.S. Cl. 705/14

(57) ABSTRACT

Methods and apparatus for implementing promotional reward programs are provided. It is determined whether a user is eligible for a debit code reward; and upon determination of eligibility, a user is provided with a debit code reward, wherein the debit code reward is a debit code associated with a predetermined value and is instantly provided to the user and the debit code is usable to purchase one or more products or services.

### REFERENCE TO RELATED APPLICATIONS

The present disclosure is based on and claims the benefit of Ser. No. 11/643,234, filed Dec. 20, 2006, entitled “Methods For Implementing A Promotional Reward Program”, the entire contents of which are herein incorporated by reference.

### BACKGROUND

1. Field of the Invention

The present disclosure relates generally to promotional reward programs, and more particularly, to a method and apparatus for implementing a promotional reward program whereby a debit code can instantly be provided to a user and used to purchase a predetermined product or service.

2. Background of the Invention

In order to encourage the purchase of goods and services in the consumer market or to improve the performance of a company's personnel, companies often use promotional reward programs that provide individuals with promotional rewards. The promotional rewards may involve, for example, companies giving away goods or services and/or discounts on goods and services, provided an individual has met certain predetermined criteria. The predetermined criteria could be anything from the purchase of a particular product to the achievement of a particular goal, such as reaching a certain amount of sales over time.

Companies administer these promotional rewards in a variety of ways. For example, upon meeting predetermined criteria, companies may provide individuals with a coupon/promotional number or a physical rebate check, which they could use to redeem their reward and obtain a particular product. However, to receive the promotional reward, an individual may have to wait for a certain amount of time until the reward is validated and sent to the individual. This process can be time-consuming and may pose a problem if the reward is lost, for example, through the U.S. mail. Moreover, an individual may not have the promotional award available when they want to redeem it. For example, an individual who is already at the movies cannot use his voucher for a free movie ticket if he has left the voucher at home. Certain retail establishments will not process any promotional rewards without having the physical reward available to them.

Accordingly, there is a need for providing a promotional reward program that allows companies to easily manage their promotional reward programs and individuals to instantly obtain promotional rewards for redemption at, for example, a retail establishment.

### SUMMARY OF THE INVENTION

It is an object of the invention to provide a method for implementing a promotional reward program, including, determining whether a user is eligible for a debit code reward; and upon determination of eligibility, providing the user with a debit code reward, wherein the debit code reward is a debit code associated with a predetermined value and is instantly provided to the user and the debit code is usable to purchase one or more products or services.

It is another object of the invention to provide a method for implementing a promotional reward program, including determining whether a user is eligible for a debit code reward, and upon determination of eligibility, providing the user with a debit code reward in real time, wherein the debit code reward is a debit code associated with a predetermined value and is instantly provided to the user via Internet, by email, by text message, on a coupon, from a kiosk, or on a receipt at a point-of-sale and the debit code is usable to purchase one or more movie tickets, books, music or other products or services that may be purchased in a retail establishment.

It is another object of the invention to provide an apparatus for implementing a promotional reward program, including a unit for determining whether a user is eligible for a debit code reward; and upon determination of eligibility, a unit for determining whether a user is eligible for a debit code reward; and upon determination of eligibility, a unit for providing the user with a debit code reward, wherein the debit code reward is a debit code associated with a predetermined value and is instantly provided to the user and the debit code is usable to purchase one or more products or services.

It is another object of the invention to provide an apparatus for implementing a promotional reward program, including, a unit for determining whether a user is eligible for a debit code reward, and upon determination of eligibility, a unit for providing the user with a debit code reward in real time, wherein the debit code reward is a debit code associated with a predetermined value and is instantly provided to the user through the Internet, by email, by text message, on a coupon, from a kiosk, or on a receipt at a point-of-sale and the debit code is usable to purchase one or more movie tickets, books, music or other products or services that may be purchased in a retail establishment.

It is another object of the invention to provide a method for implementing a promotional reward program, including, providing a user with a unique promotion code associated with a predetermined product or service, allowing the user to input the unique promotion code for verification, verifying the unique promotion code to see if it is valid, and upon verification of the unique promotion code, providing the user with a debit code for the predetermined product or service, wherein the debit code is associated with a predetermined value and is instantly provided to the user via Internet, by email, by text message, or from a kiosk, and the debit code is used to purchase a predetermined product or service.

It is another object of the invention to provide a method for implementing a promotional reward program, including, providing a user with a unique promotion code by email, text message, on a coupon, or from a website, wherein the unique promotion code is associated with a predetermined product or service, which is one or more movie tickets, books, music or other products or services that may be purchased in a retail establishment, allowing the user to input the unique promotion code for verification, verifying the unique promotion code to see if it is valid; upon verification of the unique promotion code, providing the user with a debit code for the predetermined product or service, wherein the debit code is a sixteen digit number or a bar code associated with a predetermined value, and is instantly provided to the user via Internet, by email, by text message, or from a kiosk, and allowing the user to input the debit code by email, text message, at a kiosk, or through an Internet website to purchase the predetermined product or service.

### BRIEF DESCRIPTION OF THE DRAWINGS

The features of the present application can be more readily understood from the following detailed description with reference to the accompanying drawings wherein:

FIG. 1 is a flow chart illustrating a method for implementing a promotional reward program, according to one embodiment of the present invention;

FIG. 2 is a flow chart illustrating a method for implementing a promotional reward program, according to another embodiment of the present invention;

FIG. 3 is a flow chart illustrating a method for implementing a promotional reward program by using a cellular phone, according to an embodiment of the present disclosure;

FIG. 4 is a flow chart illustrating a method of obtaining the debit code to purchase movie tickets, according to an embodiment of the present disclosure;

FIG. 5 is a screen shot illustrating the step of allowing the user to enter the unique promotion code for verification, according to an embodiment of the present disclosure;

FIG. 6 is a screen shot illustrating the step of allowing the user to enter identifying information, according to an embodiment of the present disclosure;

FIG. 7 is a screen shot illustrating the step of providing the user with the opportunity to download the debit code for the predetermined product or service, such as a movie ticket, according to an embodiment of the present disclosure;

FIG. 8 is a screen shot illustrating the step providing the user with a debit code instantly through the Internet, according to an embodiment of the present disclosure;

FIG. 9 is a screen shot illustrating the step of using the zip code to locate retail establishments participating in the promotional reward program, according to an embodiment of the present disclosure;

FIG. 10 is a flow chart illustrating the implementation of a promotional reward program in real-time, according to an embodiment of the present disclosure; and

FIG. 11 is a block diagram illustrating the implementation of a promotional reward program in real-time, according to an embodiment of the present disclosure.

### DETAILED DESCRIPTION OF THE PREFERRED EMBODIMENTS

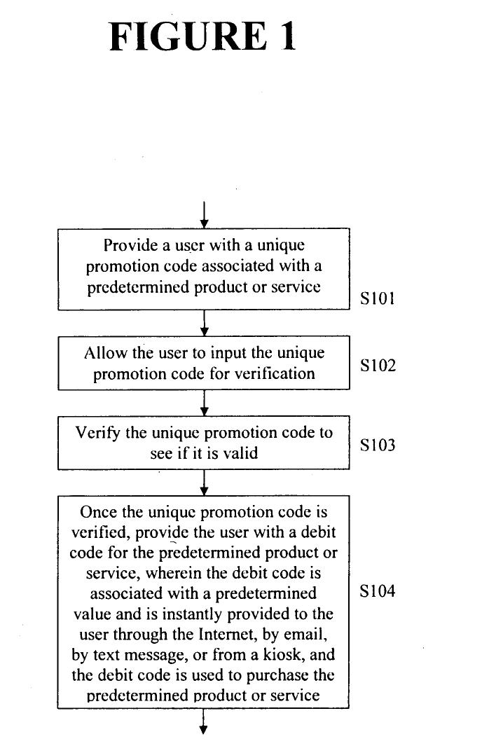

The present invention provides tools for implementing a promotional reward program. FIG. 1 is a flow chart illustrating a method for implementing a promotional reward program, according to one embodiment of the present invention. A user is provided with a unique promotion code that is associated with a predetermined product or service (Step S101). The unique promotion code can be any combination of numbers, letters, or characters and may be provided to the user, for example, in/on the package of a purchased product. The unique promotion code can be printed directly on the package or can be part of an insert in the package. According to an embodiment, other methods of distribution may be utilized, such as, by email, text message, on a coupon, from a website, through direct mailings, on a receipt, as part of a new membership welcome kit and/or incentive program services, such as Catalina Marketing®. The predetermined product or service may be one or more movie tickets, books, music or other products or services that may be purchased in a retail establishment. According to an embodiment, the predetermined product may be purchased and downloaded from a website directly onto a user's desktop computer, laptop computer, portable media player or cell phone. For example, the user may download one or more movies or songs from an online store.

The user inputs the unique promotion code for verification (Step S102). For example, the user can go to a website, and enter the unique promotion code to be validated, or can enter the unique promotion code by email, text message, or at a kiosk. If it is determined that the unique promotion code is invalid or could not be verified, the user is provided with a notification indicating that the unique promotion code is invalid. If it is determined that the unique promotion code has already been activated, the user is provided with a notification indicating that the unique promotion code has already been activated. If it is determined that the same user previously activated the unique promotion code, the user is provided with the debit code along with the notification that the unique promotion code has already been activated.

If the validity of the unique promotion code is verified (Step S103), the user is provided with a debit code for the predetermined product or service (Step S104). The debit code is associated with a predetermined value and is instantly provided to the user through the Internet, by email, by text messaging, or from a kiosk and is used to purchase the predetermined product or service. For example, the user can print the debit code for the predetermined product or service from the Internet, from the email or from the kiosk. The user may also use the debit code at an online store to purchase the predetermined product or service. If the user chooses to utilize the debit code at an online store, he/she may not have to print it. According to an embodiment, the debit code may be a sixteen digit number, such as those used for credit cards and/or debit cards, and/or a bar code.

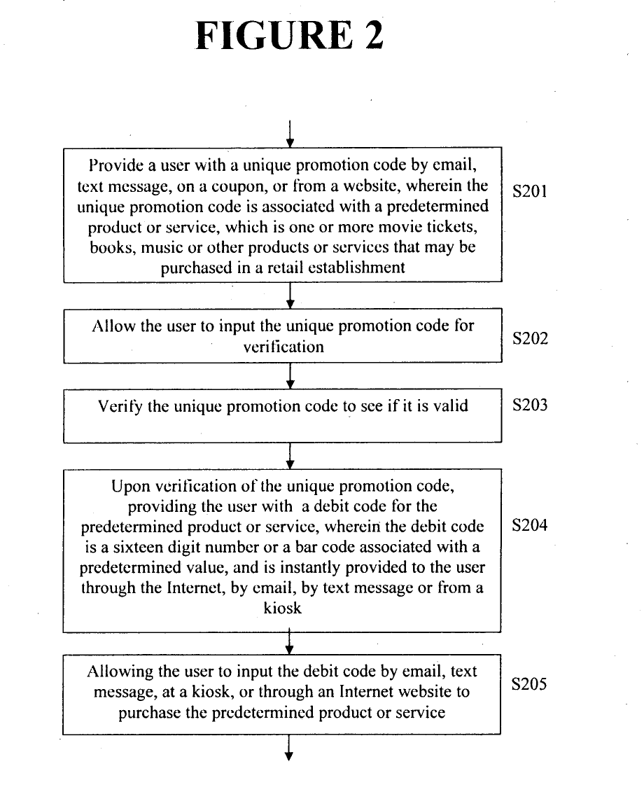

FIG. 2 is a flow chart illustrating a method for implementing a promotional reward program, according to another embodiment of the present invention. A user is provided with a unique promotion code by email, text message, on a coupon or from a website, where the unique promotion code is associated with a predetermined product or service, which is one or more movie tickets, books, music or other products or services that may be purchased at a retail establishment (Step S201). The user inputs the unique promotion code for verification (Step S202). If the validity of the unique promotion code is verified (Step S203), the user is provided with a debit code for the predetermined product or service, where the debit code is a sixteen digit number or a bar code associated with a predetermined value and is instantly provided to the user through the Internet, by email, through text messaging, or from a kiosk (Step S204). The user may input the debit code by email, text message, at a kiosk, or through an Internet website to purchase the predetermined product or service (Step S205).

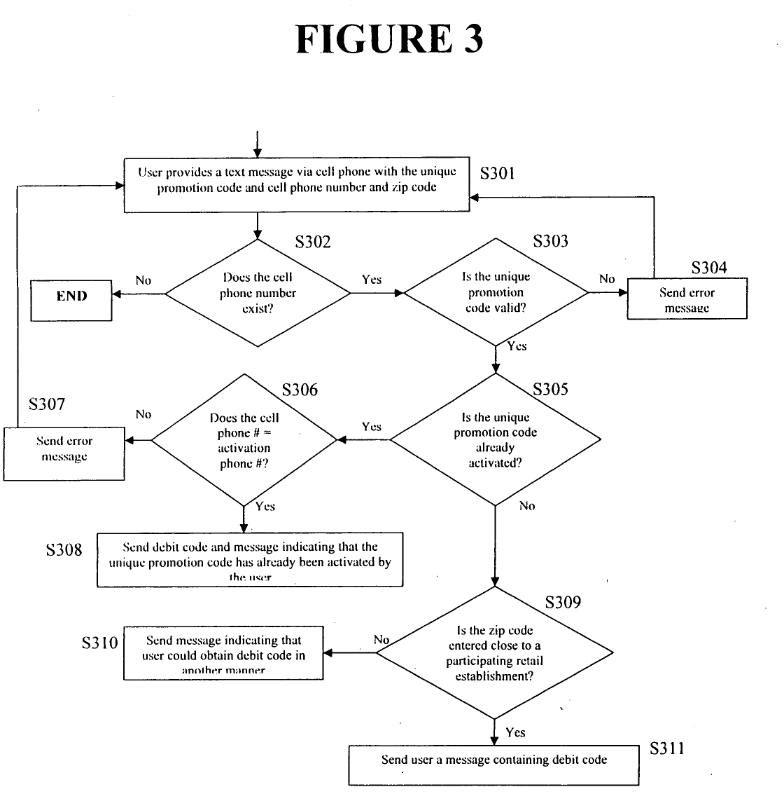

At a retail establishment, a user may purchase the predetermined product or service by showing the sales clerk the debit code on the screen, for example, of the user's cellular phone. The debit code can be sent, for example, to the user's cell phone by email or Short Message Service (“SMS”), also known as text messaging. FIG. 3 is a flow chart illustrating a method for implementing a promotional reward program by using a cellular phone, according to an embodiment of the present disclosure. To obtain the debit code, the user can provide a text message including the unique promotion code and his/her cellular phone number and a zip code by text message via the cellular phone (Step S301). According to an embodiment, the zip code is used to locate the retail establishments that accept debit codes for purchases, closest to the location of the user. For example, not every retail location may be able to complete a purchase by utilizing the debit code from the screen of a user's cell phone and may require a physical coupon/card/voucher, etc.

The cellular phone number is provided so that the system can respond to the user. If it is determined that the cellular phone number is invalid (No, Step S302), the method ends. If it is determined that the cellular phone number is valid (Yes, Step S302), it is then determined whether or not the unique promotion code is valid (Step S303). If it is determined that the unique promotion code is invalid (No, Step S303), then an error message is sent indicating that the code is invalid (Step S304). The user can then re-enter the code, if necessary (Step S301). If it is determined that the unique promotion code is valid, (Yes, Step S303), it is then determined whether or not the unique promotion code has been previously activated (Step S305). If it is determined that the unique promotion code has been previously activated (Yes, Step S306), the system determines if the cell phone number provided by the user in Step S301 is the same as the activation phone number (Step S306). If it is the same number (Yes, Step S306), the user is sent a message with the debit code and an indication that the user previously activated the unique promotion code (Step S308). If it is not the same number (No, Step S306), an error message is sent to the user indicating that the code has been activated by another phone number and the system loops back to Step S301. If it is determined that the unique promotion code has not been previously activated (No, Step S306), the system determines whether the zip code entered in Step S301 is close to a retail establishment location which accepts debit codes for purchases (Step S309). A zip code may be close enough to a participating retail establishment if it is within a reasonable distance, such as 10-15 miles, for example. If the entered zip code is not close enough to such a participating retail establishment (No, Step S309), then the user is sent a message indicating that there are no participating retail establishments close enough to the user and the user can obtain the debit code in another manner (Step S310). For example, the user can obtain a printed copy of the debit code by visiting a web-site to print out the debit code. The user also may obtain a debit code at a specific store, or may obtain the debit code via mail. If the entered zip code is close enough to a participating retail establishment (Yes, Step S309), then the user is sent a message containing the debit code (Step S311). The user may then utilize the debit code to purchase a predetermined product or service. For example, if the user wants to purchase movie tickets, he/she may show the sales clerk the debit code on the screen of the cell phone. The sales clerk can then input the debit code and the transaction can be processed just like a traditional “debit card” or “credit card” transaction.

According to an embodiment of the present disclosure, the debit code is a sixteen digit number or a bar code that is associated with a predetermined value and may be provided by a bank. For example, a company or any other service may deposit $10,000 into a bank account and instruct the bank or any other service to issue 5,000 debit codes, where each code is associated with a $2.00 value. When a user enters the unique promotional code for verification, upon validation, the system will assign one of the 5,000 debit codes associated with a $2.00 value to the user. When the debit code is processed at a retail location or an online site for a predetermined product or service in the amount of $2.00, the processor verifies that the bank has the $2.00. The debit code may be processed either by scanning the bar code or inputting the sixteen digit number. The number may be sixteen digits so that it can be utilized by merchants in the same manner as sixteen digit “credit card” or “debit card” numbers to pay for merchandise.

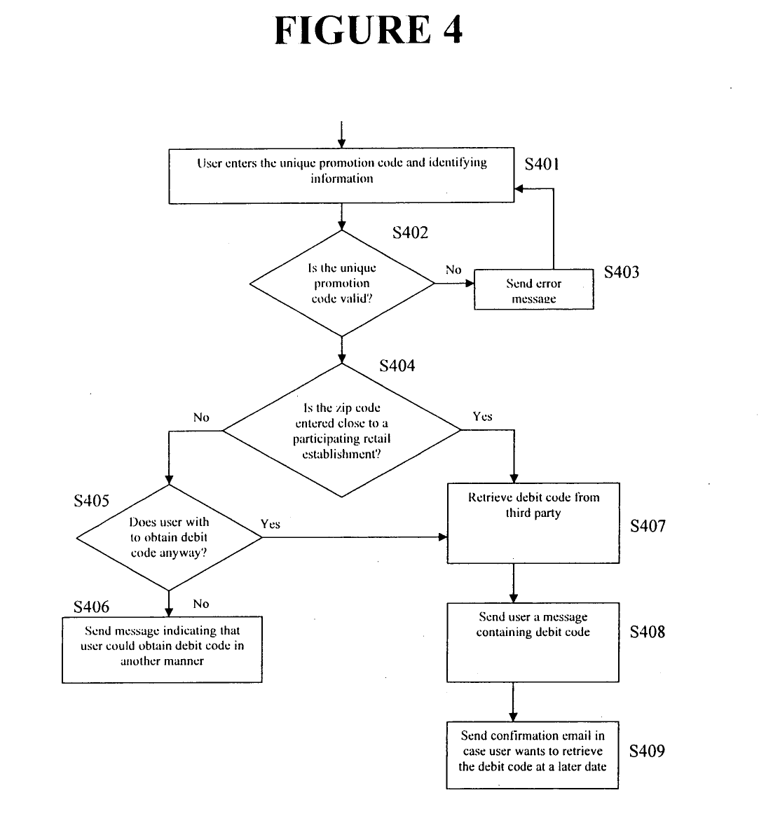

According to an embodiment, the debit code may be used to purchase a predetermined product or service, such as, for example, movie tickets. FIG. 4 is a flow chart illustrating a method of obtaining the debit code to purchase movie tickets, according to an embodiment of the present disclosure. The user enters the unique promotion code and other identifying information (Step S401) either by email, text message, at a kiosk, or through an Internet website. The identifying information comprises one or more of the following: user's first name, user's last name, user's address, user's email address, zip code, and/or telephone number. According to an embodiment, the identifying information may be verified and a user may be prompted to re-enter the identifying information if it is not verified. For example, identifying information may be invalid if the entered zip code is not five digits.

If it is determined that the unique promotion code is invalid (No, Step S402), then an error message is sent indicating that the code is invalid (Step S403). The error message may be sent by email or text message or displayed at a kiosk or Internet website. The user can then re-enter the code, if necessary (Step S401). If it is determined that the unique promotion code is valid, (Yes, Step S402), it is then determined whether the system determines whether the zip code entered in Step S401 as part of the identifying information is close to a participating retail establishment location, such as a participating movie theater (Step S404). A participating retail establishment is any retail establishment which accepts debit codes for purchases. According to one embodiment, use of the debit code is not restricted to one or more particular retail establishments. If the zip code is not close enough to a participating movie theater (No, Step S404), the user has the option of obtaining the debit code regardless of the location of the participating movie theaters (Step S405). If the user chooses not to obtain the debit code at that time (No, Step S405), the user is sent a message indicating that there are no participating retail establishments close enough to the user and the user can obtain the debit code in another manner (Step S406). This message may be sent by email or text message or displayed at a kiosk or Internet website. For example, the user can visit a web-site to print out the debit code, can obtain a debit code at specific store, or can obtain the debit code via mail. If the entered zip code is close enough to a participating retail establishment (Yes, Step S404) or the user decides to obtain the debit code regardless of the location of the participating movie theaters (Yes, Step S405), the debit code is obtained from a third party (Step S407) and is sent to the user (Step S408). The user may immediately print the debit code from the Internet, from an email or from a kiosk. A confirmation email may be sent to the user in case he/she wants to be reminded of the debit code again at a later date (Step S409). According to an embodiment, the debit code may be provided to the user on a ticket along with the user's name, an expiration date, a listing of the three closest participating theaters, address, and/or email address, etc.

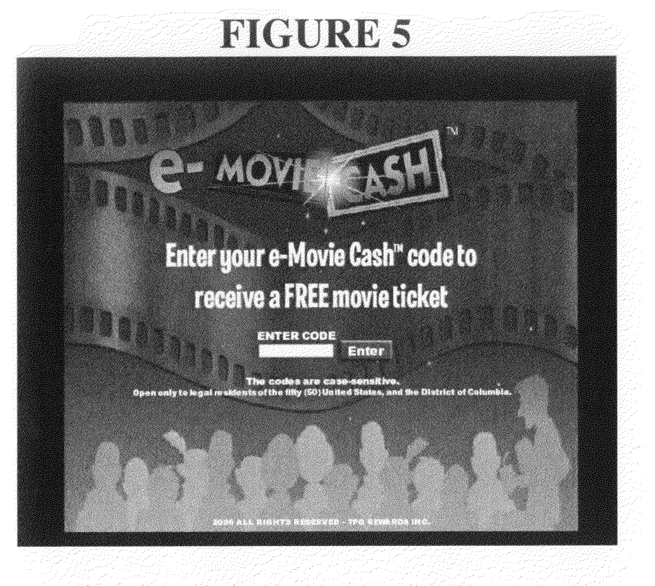

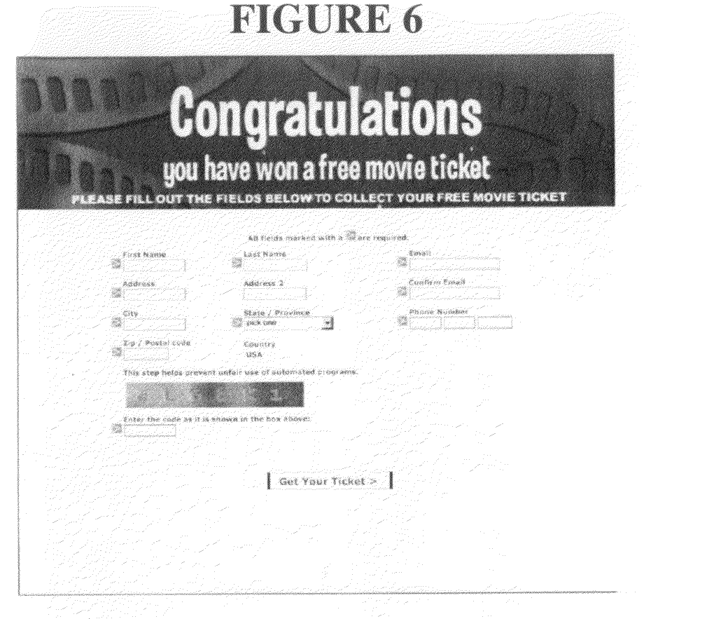

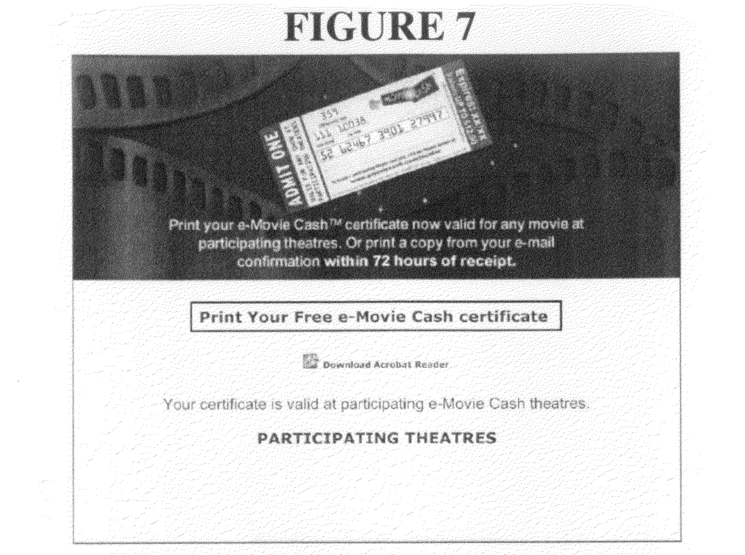

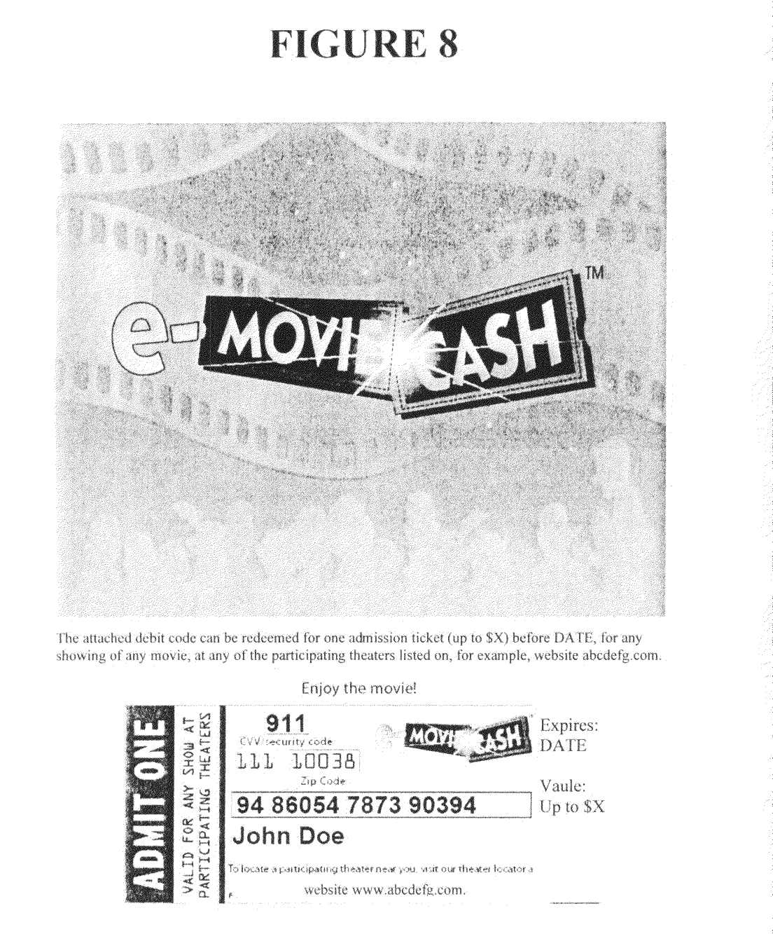

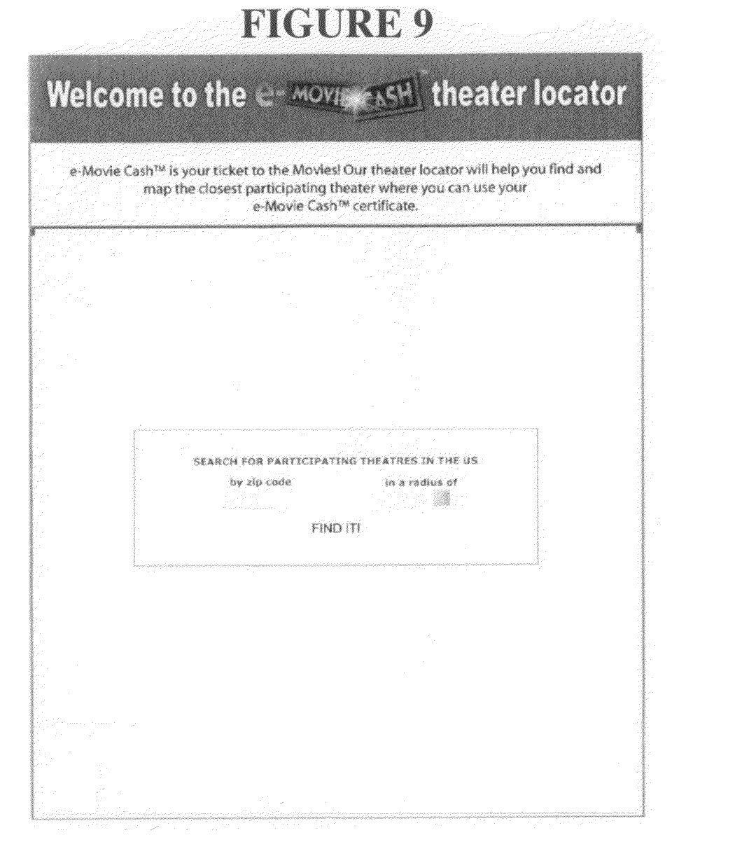

FIGS. 5-7 are screen shots illustrating an implementation of the method for awarding free movie tickets, according to an embodiment of the present disclosure. The screen shot of FIG. 5 illustrates the step of allowing the user to enter the unique promotion code for verification. The screen shot of FIG. 6 illustrates allowing the user to enter identifying information. The screen shot of FIG. 7 illustrates the step of providing the user with the opportunity to download the debit code for the predetermined product or service, wherein the debit code is associated with a free movie ticket and can be instantly downloaded and/or printed by the user from a PDF reader. Alternatively, as illustrated at the bottom of FIG. 7, the user may choose to obtain a list of retail establishments that accept debit codes for purchases in close proximity to the location of the user (click on “Participating Theaters”). For example, the screen shot of FIG. 9, according to an embodiment, illustrates the step of allowing the user to input a zip code to locate retail establishments, namely, movie theaters, participating in the free movie ticket program. If the user determines that there are no participating theaters close enough, he/she may opt to obtain the debit code in another manner, for example, the user can visit a web-site to print out the debit code, can obtain a debit code at specific store, or can obtain the debit code via mail. If the user determines that there are participating theaters close enough, he/she may obtain the debit code instantly through the Internet. FIG. 8 is a screen shot illustrating the step providing the user with a debit code instantly through the Internet, after it is downloaded in FIG. 7. According to an embodiment, the user may also obtain the debit code by email, by text message, or from a kiosk.

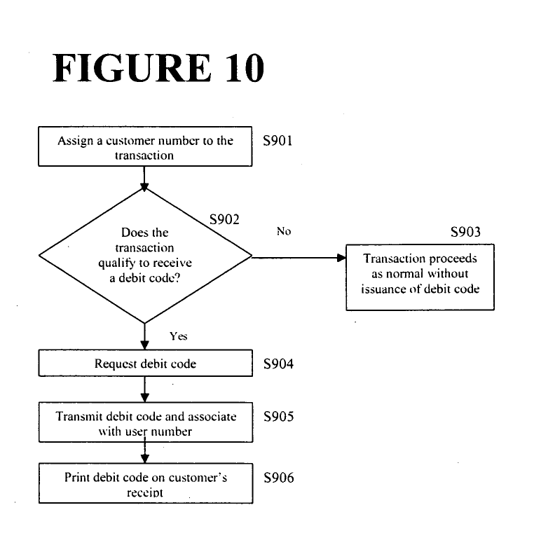

According to another embodiment of the present disclosure, the user may obtain the debit code reward directly on a receipt in real-time, for example, at a point of sale in connection with a purchase, without having to obtain a unique promotion code. FIG. 10 is a flow chart illustrating the implementation of a promotional reward program in real-time, according to this embodiment. At a point of sale (for example, at the cashier/check-out kiosk of a supermarket, department store, drug store, restaurant, through the Internet, or any other means, entity or business that provides goods and/or services for sale) in connection with a purchase, a customer number is assigned to the transaction (Step S901). A point of sale may also include any location where a consumer can purchase goods or services, such as, the home of a person purchasing goods through the Internet. According to an embodiment, the customer number may be the customer loyalty program number or any other number that is unique to the customer. It is then determined whether or not a customer transaction qualifies to receive a debit code (Step S902). For example, the purchase of a predetermined product and/or service, a total purchase amount in a predetermined amount, or membership the store's customer loyalty program may qualify the customer to obtain a debit code. If it is determined that the transaction does not qualify for the debit code (No, Step S902), the transaction proceeds as normal, with the customer paying for the goods and/or services and obtaining a receipt without a debit code (Step S903). However, if it is determined that the customer qualifies for the debit code (Yes, Step S902), a debit code may be requested (Step S904). The debit code may be requested from, for example, a debit code issuer which may be one or more of the following, which may communicate with one another: the point of sale store, a customer loyalty program, an advertising agency, a coupon code issuer (for example, Catalina Marketing), a manufacturer, and/or any third party which is in the business of issuing debit codes. The debit code is then transmitted to the requesting entity, for example, the point of sale. (Step S905). For example, the purchase may be assigned a customer number and when the debit code is received from the debit code issuer, it may be associated with the data file for that customer number. According to an embodiment, the debit code can be instantaneously provided to the user through the Internet, by email, by text message, on a coupon, from a kiosk, or any other means of instantaneous communication. For example, the debit code, according to an embodiment, may be printed on the customer's receipt (Step S906). When a customer is ready to use the debit code, it can be obtained from the receipt. According to an embodiment, the debit code is a sixteen digit number or a bar code associated with a predetermined value and may be used to purchase one or more products and/or services. For example, the debit code may be used to purchase one or more movie tickets.

One or more debit codes may reside on a server at the point of sale or may be transmitted in groups from the debit code issuer to the point of sale. According to an embodiment, the promotional reward program may be implemented through an internal system, for example, at the point of sale. When requested, the store server may issue the debit code to the requesting entity such as the point of sale, for example, a cash register. The debit code may then instantaneously be provided to the user, for example, by printing it on a coupon.

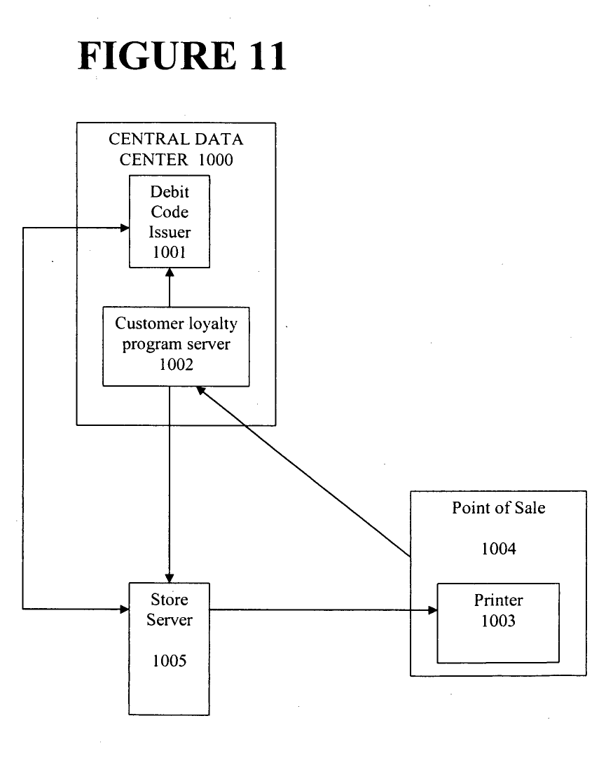

FIG. 11 is a block diagram illustrating the implementation of a promotional reward program in real-time, according to another embodiment. A customer approaches a point of sale 1004, for example, a checkout lane of a store, to purchase one or more products and/or services. The point of sale 1004 may assign the customer a customer number. The point of sale 1004, communicates with the customer loyalty program server 1002 to determine whether the customer qualifies for a debit code. For example, using the customer number the customer loyalty program server 1002 can determine if the customer is eligible to qualify for any offers based on past or present purchases. If it is determined that the customer qualifies for the debit code, the customer loyalty program server 1002 requests a debit code from the debit code issuer 1001. According to an embodiment, the customer loyalty program server 1002 may alert the store server 1005 that the user is qualified for a debit code so that it knows to wait for its receipt. If it does not receive the debit code in a predetermined amount of time, the store server 1005 may notify the customer loyalty program 1002. According to an alternate embodiment, the store server 1005 may request the debit code from the debit code issuer 1001. Both the debit code issuer 1001 and the customer loyalty program server 1002 may be located in a central data center 1000 in a remote location. The debit code issuer 1001 transmits the debit code to the store server 1005, where the store server 1005 transmits the debit code to a printer 1003 located at the point of sale 1004. The printer 1003 prints the debit code on, for example, a receipt, which is then given to the customer.

The above specific embodiments are illustrative, and many variations can be introduced on these embodiments without departing from the spirit of the disclosure or from the scope of the appended claims. For example, elements and/or features of different illustrative embodiments may be combined with each other and/or substituted for each other within the scope of this disclosure and appended claims.

What is claimed is:

1. A method for implementing a promotional reward program, comprising:
determining whether a user is eligible for a debit code reward; and upon determination of eligibility, providing the user with a debit code reward, wherein the debit code reward is a debit code associated with a predetermined value and is instantly provided to the user and the debit code is usable to purchase one or more products or services.

2. The method of claim 1, wherein the debit code is instantly printed on a receipt at a point of sale.

3. The method of claim 1, wherein the debit code is instantly provided via Internet, by email, by text message, on a coupon, or from a kiosk.

4. The method of claim 1, wherein the debit code only can be used to purchase a predetermined product or service.

5. The method of claim 1, wherein the debit code is usable to purchase a movie ticket.

6. The method of claim 4, wherein the predetermined product or service is one or more movie tickets, books, music or other products or services that may be purchased in a retail establishment.

7. The method of claim 1, wherein the debit code is a sixteen digit number.

8. The method of claim 1, wherein the debit code is a bar code.

9. The method of claim 1, further comprising allowing the user to input the debit code by email, text message, at a kiosk, or through an Internet website to purchase one or more products or services.

10. The method of claim 1, wherein the debit code is provided by a debit code issuer.

11. The method of claim 1, wherein the debit code is provided by an in-store server or computer.

12. The method of claim 1, further comprising sending the user a text message containing the debit code.

13. The method of claim 12, wherein the debit code appears on a screen of a user's cell phone and the user shows the debit code on the cell phone to a retail establishment to complete the purchase of one or more products or services.

14. The method of claim 13, wherein the debit code appearing on the screen of a user's cell phone comprises one or more of the following: a sixteen digit number, or a bar code.

15. A method for implementing a promotional reward program, comprising:
determining whether a user is eligible for a debit code reward; and upon determination of eligibility, providing the user with a debit code reward in real time, wherein the debit code reward is a debit code associated with a predetermined value and is instantly provided to the user via Internet, by email, by text message, on a coupon, from a kiosk, or on a receipt at a point-of-sale and the debit code is usable to purchase one or more movie tickets, books, music or other products or services that may be purchased in a retail establishment.

16. An apparatus for implementing a promotional reward program, comprising:
a unit for determining whether a user is eligible for a debit code reward; and upon
determination of eligibility, a unit for providing the user with a debit code reward, wherein the debit code reward is a debit code associated with a predetermined value and is instantly provided to the user and the debit code is usable to purchase one or more products or services.

17. The apparatus of claim 16, wherein the debit code is instantly printed on a receipt at a point of sale, via Internet, by email, by text message, on a coupon, or from a kiosk.

18. The apparatus of claim 16, wherein the debit code is a sixteen digit number.

19. The apparatus of claim 16, wherein the debit code is a bar code.

20. The apparatus of claim 16, further comprising means for allowing the user to input the debit code by email, text message, at a kiosk, or through an Internet website to purchase one or more products or services.

21. The apparatus of claim 16, wherein the debit code is provided by a debit code issuer.

22. The apparatus of claim 16, further comprising sending the user a text message containing the debit code.

23. The apparatus of claim 22, wherein the debit code appears on a screen of a user's cell phone and the user shows the debit code on the cell phone to a retail establishment to complete the purchase of one or more products or services.

24. The apparatus of claim 23, wherein the debit code appearing on the screen of a user's cell phone comprises one or more of the following: a sixteen digit number, or a bar code.

25. An apparatus for implementing a promotional reward program, comprising:
a unit for determining whether a user is eligible for a debit code reward; and upon determination of eligibility, a unit for providing the user with a debit code reward in real time, wherein the debit code reward is a debit code associated with a predetermined value and is instantly provided to the user via Internet, by email, by text message, on a coupon, from a kiosk, or on a receipt at a point-of-sale and the debit code is usable to purchase one or more movie tickets, books, music or other products or services that may be purchased in a retail establishment.
